(19) United States
(12) Patent Application Publication
(10) Pub. No.: US 2017/0316215 A1
(43) Pub. Date: Nov. 2, 2017

(54) POLICY-BASED AUDITING OF STATIC PERMISSIONS FOR PHYSICAL ACCESS CONTROL

(71) Applicant: Carrier Corporation, Farmington, CT (US)

(72) Inventors: Tarik Hadzic, Cork (IE); Stylianos Basagiannis, Cork (IE); Keith J. Power, Cork (IE); Menouer Boubekeur, Cork (IE); Blanca Florentino, Cork (IE); Vijaya Ramaraju Lakamraju, Longmeadow, MA (US); Philip J. Harris, Cork (IE)

(21) Appl. No.: 15/520,552

(22) PCT Filed: Aug. 24, 2015
(86) PCT No.: PCT/US2015/046495

§ 371 Date: Apr. 20, 2017

Related U.S. Application Data
(60) Provisional application No. 62/068,116, filed on Oct. 24, 2014.

(51) Int. Cl. G06F 21/60; G06F 21/31; G06F 21/62; H04L 29/06

(52) U.S. Cl. CPC G06F 21/604; G06F 21/31; G06F 21/60; H04L 63/102; G06F 21/6218

(57) ABSTRACT

A system for auditing physical access to at least one resource includes a static permission database containing a plurality of static permission records identifying access permissions for at least one credential holder to the at least one resource, a policy database containing a plurality of policies, a processor to execute at least one policy of the plurality of policies to generate an outcome of execution of at least one policy to compare the outcome of execution of at least one policy with at least one appropriate static permission records of the plurality of static permission records, and a scheduler to trigger the processor to execute and compare the outcome of execution of at least one policy with the at least one appropriate static permission records in response to at least one of an occasional event, a schedule, or an action by administrator.

### FIELD OF THE INVENTION

The subject matter disclosed herein relates to policy-based auditing of static permissions for physical access control, and to a system and a method for policy-based auditing of static permissions for physical access control.

### DESCRIPTION OF RELATED ART

Typically, physical access control systems, e.g. building access control systems, ensure that only authorized users (credential holders, cardholders) have the ability to access protected areas and under correct circumstances. For example, a physical access control system may compare a provided credential to a stored static permission to allow or deny access to an area at a given time. Further, such a static permission may refer to a single resource (a single reader) or a grouping of resources (a collection of readers in a certain area). Static permission may also refer to circumstantial conditions (such as time during the week) when the access is allowed or denied.

Physical access control systems require administrative tasks to add, remove, and update static permissions to ensure proper static permissions and the effective use of the physical access control system. Administrative tasks traditionally utilize manual operations, consuming time and introducing the risk of incorrect permission records. Rule-based policies can effectively manage dynamic changes that affect correctness of permission records, such as changes to user properties, organizational structure, resource properties (such as sensitivity levels) etc. Existing access control systems that use such rule-based policies are using them for dynamic processing of individual requests for access which requires a system that is capable of running a rule engine in real time to process access requests. Such systems capable of dynamic processing are often incompatible with existing physical access control systems which use a software and hardware architecture that requires availability of static permissions to determine access. Replacing architecture of existing physical access control systems to enable dynamic use of rule-based policies would be costly and impractical. A system and method that can utilize rule-based policies with existing access control systems to automate the management of static permissions is desired.

### BRIEF SUMMARY

According to one embodiment of the invention, a system for auditing physical access to at least one resource includes a static permission database containing a plurality of static permission records identifying access permissions for at least one credential holder to the at least one resource, a policy database containing a plurality of policies, a processor to execute at least one policy of the plurality of policies to generate an outcome of execution of at least one policy to compare the outcome of execution of at least one policy with at least one appropriate static permission records of the plurality of static permission records, and a scheduler to trigger the processor to execute and compare the outcome of execution of at least one policy with the at least one appropriate static permission records in response to at least one of an occasional event, a schedule, or an action by administrator.

In addition to one or more of the features described above, or as an alternative, further embodiments could include that each of the plurality of policies is a collection of one or more rules and each rule including at least one of user properties, resource properties, and environment properties as well as including an access decision which determines whether a corresponding user satisfying the user properties can or cannot have access to the at least one resource satisfying the resource properties, in an environment satisfying the environment properties.

In addition to one or more of the features described above, or as an alternative, further embodiments could include that each of the plurality of policies includes a conflict resolution strategy to determine a rule priority for rules within a policy.

In addition to one or more of the features described above, or as an alternative, further embodiments could include a violation database containing a plurality of static permission records which violate one or more of policies as computed by the processor.

In addition to one or more of the features described above, or as an alternative, further embodiments could include an exception database containing a plurality of exception static permission records exempt from the plurality of policies.

In addition to one or more of the features described above, or as an alternative, further embodiments could include that the processor is configured to add a new static permission record or remove one of the plurality of static permission records.

According to one embodiment of the invention, a method of auditing physical access to at least one resource includes providing a plurality of static permission records in a static resource database identifying access permissions for at least one credential holder to the at least one resource, providing a plurality of policies in a policy database, executing at least one policy of the plurality of policies via a processor to generate an outcome of execution of at least one policy, comparing the outcome of execution of at least one policy with at least one appropriate static permission records of the plurality of static permission records via the processor, and triggering the processor to execute and compare the outcome of execution of at least one policy with at least one appropriate static permission records in response to at least one of an occasional event, a schedule via a scheduler, or an action taken by administrator.

In addition to one or more of the features described above, or as an alternative, further embodiments could include that each of the plurality of policies is a collection of one or more rules and each rule including at least one of a group consisting of user properties, resource properties, and environment properties as well as including an access decision which determines whether a corresponding user satisfying the user properties can or cannot have access to the at least one resource satisfying the resource properties, in an environment the satisfying environment properties.

In addition to one or more of the features described above, or as an alternative, further embodiments could include determining a rule priority for rules within a policy of each of the plurality of policies via at least one conflict resolution strategy.

In addition to one or more of the features described above, or as an alternative, further embodiments could include recording a plurality of violations in a violation database.

In addition to one or more of the features described above, or as an alternative, further embodiments could include providing a plurality of exception static permission records exempt from the plurality of policies in an exception database.

In addition to one or more of the features described above, or as an alternative, further embodiments could include adding a new static permission record or removing one of the plurality of static permission records via the processor.

In addition to one or more of the features described above, or as an alternative, further embodiments could include specifying at least one of the plurality of policies via a graphical user interface.

According to one embodiment of the invention, a computer program product embodied on a tangible computer readable storage medium includes providing a plurality of static permission records in a static resource database identifying access permissions for at least one credential holder to at least one resource, providing a plurality of policies in a policy database, executing at least one policy of the plurality of policies via a processor to generate an outcome of execution of at least one policy, comparing the outcomes of execution of at least one policy with at least one appropriate static permission records of the plurality of static permission records via the processor, and triggering the processor to execute and compare the outcome of execution for at least one policy with appropriate static permission records in response to at least one of an occasional event or a schedule or an action by administrator.

Technical function of the embodiments described above includes executing at least one policy, comparing the policy result with appropriate static permission records and scheduling the executing of the at least one policy and the comparing of the policy result with at least one static permission record.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a schematic view of a physical access control system in accordance with an embodiment of the invention;

FIG. 2 illustrates a schematic view of an exemplary management system for use with a physical access control system in accordance with an embodiment of the invention; and

FIG. 3 is a flow diagram of a method of policy based management of static permissions within a physical access control system in accordance with an embodiment of the invention.

### DETAILED DESCRIPTION OF THE INVENTION

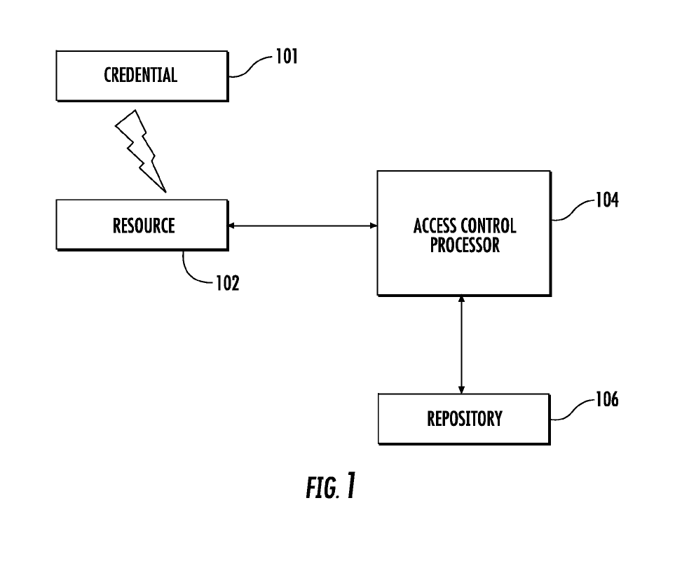

Referring now to the drawings, FIG. 1 illustrates a general schematic of an exemplary physical access control system 100 for use with the policy-based management system and method in accordance with an embodiment of the invention. In an embodiment, physical access control system 100 is a physical access control system to control access to resources. Physical access control system 100 includes resource 102, access control processor 104, and repository 106.

Resource 102 of physical access control system 100 may include areas or resources that are secured by readers, locks, doors, or other physical barriers. In an exemplary embodiment, credentials 101, such as identification cards supplied by an administrator are used to interface with resource 102. In certain embodiments, the resources can be physical or logical. In certain embodiments, multiple resources 102 are grouped together in collections of resources in a certain area.

Repository 106 contains static permission records that provide access information regarding specific users and specific resources. In an exemplary embodiment, static permission records include information regarding circumstantial access, such as time of day. In certain embodiments, static permission records provide, allow, or deny determination for a certain user, with corresponding credentials, for a certain resource or group of resources for a certain time of day. As previously discussed, adding, removing, updating and generally managing these static permissions may be time intensive and introduce errors. Repository 106 may contain multiple databases or repositories.

Access control processor 104 may be a general-purpose processor executing operations in response to program instructions stored on a storage medium. Access control processor 104 receives inputs from resource 102 and processes inputs received and creates an allow or deny determination based on records stored in repository 106. In an exemplary embodiment, access control processor 104 provides a real time or near real time determination to allow or deny a user access based on static permission records. The access control processor 104 responds to a request for entry by checking whether there is a static permission stored in the system that would allow the credential to unlock the door at the given time of day, only if such a permission is stored is access to the resource granted. Conventionally, access control processor 104 is a simple processor to compare credentials provided by resource 102 to static records received by repository 106. Advantageously, such processors may include legacy systems that are previously installed, allowing cost effective and reliable operation. A rule based policy management system that interfaces with such a system allows for streamlined, automated, and more robust management of static permissions without introducing the cost of replacing a legacy access system that utilizes a basic static permission processor.

Although a particular physical access control system is illustrated and described in the disclosed embodiment, it will be appreciated that other configurations and/or machines include other access control systems that may operate in commercial buildings, vehicles, and other applications may also benefit from embodiments disclosed.

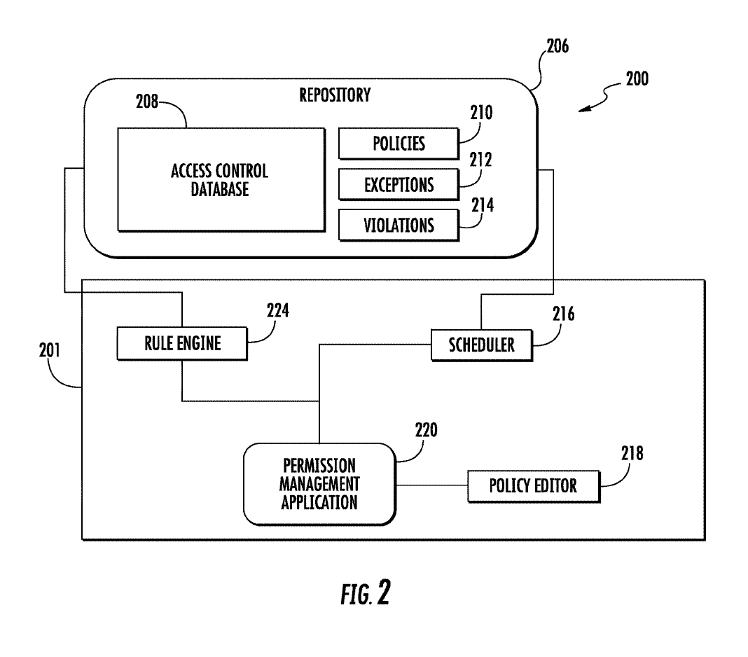

As illustrated in FIG. 2, rule-based management system 200 interfaces with repository 206. Rule-based management system 200 includes a processor 201, which may be part of a computer or server. Processor 201 may be a general-purpose processor executing operations in response to program instructions stored on a storage medium. In an exemplary embodiment, repository 206 is a repository of a physical access control system that utilizes static permissions to perform an allow or deny determination with respect to a resource or a group or resources. Management system 200 includes repository 206, scheduler 216, management application 220, rule engine 224. Components of management system 200 may be physically connected or operatively connected.

In an exemplary embodiment, repository 206 contains access control database 208, policy database 210, exception database 212, and violation database 214. In certain embodiments, repository 206 contains a combination of access control database 208 and a group including, but not limited to policy database 210, exception database 212, and violation database 214.

In exemplary embodiments, access control database 208 includes the information contemplated in access control database of repository 106. In certain embodiments, access control database 208 contains standard data captured by an access control system, such as information about users, resources, permissions, activity logs etc.

In an exemplary embodiment, policy database 210 contains rule-based policies to manage the static permissions of a physical access control system, such as physical access control repository 106. Such policies describe appropriate access permissions as an outcome of logical rules based on the properties of users, resources and environment, where resources refer to areas, doors, locks etc. and environment refers to time, threat level etc. For example, a policy might contain Rules 1 and 2 where Rule 1 states that users who are not US persons should not have access at any given time to areas designated as being subject to export control, while Rule 2 states that users who are members of Engineering department should have access to areas designated as research labs during weekdays from 7 am. to 8 pm. In an exemplary embodiment multiple policies are stored in the repository. In certain embodiments, policies include specification of a conflict resolution strategy which is used to determine the policy decision over a specific user and permission in case that some rules provide conflicting decisions regarding allowing or denying access. In the above example, Rule 1 and Rule 2 would provide conflicting decisions about whether users who are non-US persons and members of Engineering department can access research labs which are subject to export control. If the above policy includes a conflict resolution strategy that prioritizes rules involving export control over general rules, the decision effect of Rule 1 would overrule the effect of Rule 2 and the final policy decision would be to deny access.

Such rule-based policies allow for automated audit of static permissions. By applying general, dynamic rules instead of manually examining individual static permissions, static permissions can be audited effectively. For example, by applying the rule-based policy from previous example over the database of static permission records, where each record indicates which users have access to which areas, we can automatically detect if any non-US person in the database has access to an export-controlled lab or whether any US-person member of Engineering department is missing an access to a research lab. Once detected, those deviations from the policy can be automatically fixed.

In exemplary embodiments, these policies are evaluated or executed by a rule engine 224 to compute static permissions compatible with the policy and/or to compare against the static permission records and/or to raise violations when incompatibility between policy and relevant static permission records in the database is detected

Management application 220 allows for execution and audit of the rule based policies of policy database 210. Management application 220 manages information about users and permissions in the access control database 208 for different application-specific purposes within the organization. The management application 220 allows resolution of violations via interaction with an administrator, or automatically, using a predefined set of corrective actions. In certain embodiments, these corrective actions include adding, removing or updating static permissions, cardholder properties, resource properties etc. In other embodiments, static permissions are added or removed to fix a violation.

In exemplary embodiments, management application 220 allows administrators to automatically identify access permissions, which violate a selected policy and register them in the violations repository 214, and then analyze and resolve policy violations. In certain embodiments, management application 220 further declares exceptions (which can also include expiration dates) to policy violations in exceptions repository 212, which are then no longer considered as violations until the exception has expired or explicitly revoked. In certain embodiments, management application 220 in conjunction with scheduler 216 continuously or occasionally monitors for policy violations. The monitoring may be based on a predetermined schedule (every hour, day, week, . . . ) or based on specific event triggers (after cardholder profile update, rule update, resource update etc.). In other embodiments, monitoring may be scheduled by management application 220 alone, scheduler 216, or by any other suitable means or combination.

In exemplary embodiments, scheduler 216 triggers management application 220 at desired times or events. Real-time policy based systems require complex and extensive processing systems to provide real time determinations to allow or deny access to a resource. Advantageously, scheduler 216 may trigger the rule-based management system 200 to apply the rule-based policies on a set schedule that is less resource intensive. The application of rule-based policies can also result in response to explicit action of a system administrator who runs the management application. Further, the use of scheduler 216 allows for the use of existing legacy physical access systems that utilize static permissions without requiring major component changes to allow for real time determinations of access using rule based policies. In an exemplary embodiment, the management application 220 does not evaluate and execute policies under real time resource requests.

In certain embodiments, scheduler 216 may trigger management application 220 in response to certain events. Such events may include organizational changes, adding of users, adding of user groups, removal of user groups, changes in user properties, changes in resource properties (such as sensitivity levels), addition or removal of resources, changes in collection of resources, etc. Similarly, by triggering management application 220 at certain times, resources required to process the rule based policies are effectively utilized. In certain embodiments, the functions of scheduler 216 are triggered by an administrator or certain administrator actions, either manually or in response to other administrator inputs. In other embodiments, triggering management application 220 occurs upon an occasional event, such as when a credential 101 (e.g., a key card) is presented to a resource 102 (e.g., card reader).

In certain embodiments, rule engine 224 evaluates and executes the policies with the user information and conditional information provided by management application 220. In certain embodiments, the functionality of rule engine 224 is incorporated in management application 220, while in other embodiments, rule engine 224 is a separate component, while in other embodiments rule engine 224 is configured in any suitable manner.

In an exemplary embodiment, the violations database 214 contains records of violations wherein the static permissions differ from the expected results. After the policy is applied to a specific user or a group of users, the result is compared to each of the respective static permissions to record deviations, or violations. In an exemplary embodiment, such violations can result when deviations include more permissions than expected or less permissions than expected. In an exemplary embodiment, resulting violations can result in the static permission being altered, the rule being changed or an exception being granted for the static permission. In an exemplary embodiment, violations repository or database 214 contains the list of violations, including the violations that occurred in the past or that are currently active. For each violation, violation repository 214 stores a reference to the particular version of the policy that it was violating as well as the date/time it was detected.

In an exemplary embodiment, exceptions database 212 contains records of exceptions, which are designated as exempt from requirement to satisfy policies allowing an evaluated exception to continue to violate a rule or policy. In certain embodiments, exceptions can also be associated with an expiration time, after which the permission non-compliant with a policy would be considered as a violation.

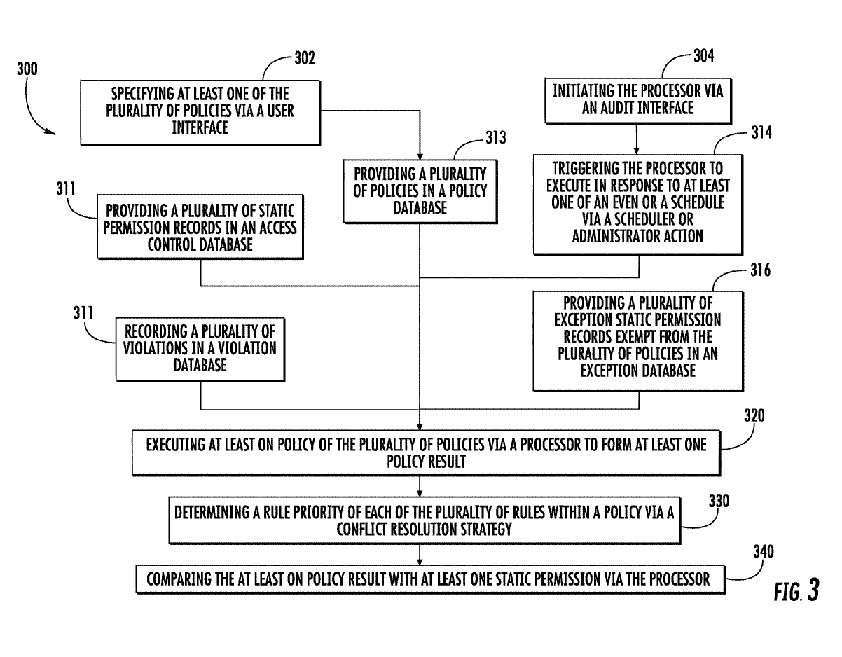

FIG. 3 illustrates a method 300 for managing a physical access control system using rule based policies. In operation 302 at least one policy, of a plurality of potential policies is created, for example, via a graphical user interface, direct textual input or through some other means. In an exemplary embodiment the policies are created in any suitable way.

In operation 304 an audit schedule is created via an interface to scheduler 216. Scheduler 216 may include a scheduler interface that allows a user to define events and/or time period(s) that initiate management of static permissions. The schedule or triggering events may be any suitable configuration, including but not limited to the methods previously described. As noted above, scheduler 216 may be configured to launch management application 220 when a credential 101 is presented at resource 102.

In operation 311, a plurality of static permission records are provided in a static resource database. In certain embodiments, the static permission records are pre-existing from an existing management scheme or exist as a result of the current management method, or a combination thereof. In an exemplary embodiment, the access control database contains standard data captured by an access control system, such as information about users, resources, permissions, activity logs etc.

In operation 312, a plurality of violations are recorded in the violation database. In an exemplary embodiment, the violation database contains the list of violations, including the violations that occurred in the past or that are currently active. In certain embodiments, for each violation, the violation repository stores a reference to the particular version of the policy that it was violating as well as the date/time it was detected.

In operation 313 a plurality of policies is provided in the policy database. In an exemplary embodiment, the policies may be previously recorded or could be recorded using the method herein. The policies may be recorded via operation 302 described above. In an exemplary embodiment, policy repository includes policies which describe appropriate access permissions as an outcome of logical rules based on the properties of users, resources and environment.

In operation 314, processor 201 is triggered to execute in response to at least a schedule or an exception event or explicit administrative action. The schedule may be determined to utilize available resources as previously described. In certain embodiments, exception events may be used to trigger an audit, such as organizational changes or new users.

In operation 316, a plurality of exception static permissions are recorded. After the violations are reviewed, exception static permission records are recorded that do not comply with the defined policies. In certain embodiments, the exception database as previously described is utilized. In other embodiments, any suitable method is utilized.

In operation 320, at least one policy of the defined plurality of policies is executed. In an exemplary embodiment, the policy is evaluated as previously described.

In operation 330, a priority of each rule within the policy is determined and established. In an exemplary embodiment, the priority determines if two policies are in conflict and which policy dictates the static permission records.

In operation 340, the policies are executed over user profiles and compared with their static permissions using rule engine 224 to verify the static access permissions. This can result in detecting missing permissions or policy violations. In the event that two rules result in different results (e.g., grant or deny access) rule priorities (as set in 330) may be used to resolve conflicts. In other embodiments any suitable method to compare the results with the previously established permissions is utilized.

As described above, exemplary embodiments can be in the form of processor-implemented processes and devices for practicing those processes, such as processor 201. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system for auditing physical access to at least one resource, the system comprising:
a static permission database containing a plurality of static permission records identifying access permissions for at least one credential holder to the at least one resource;
a policy database containing a plurality of policies;
a processor to execute at least one policy of the plurality of policies to generate an outcome of execution of at least one policy to compare the outcome of execution of at least one policy with at least one appropriate static permission records of the plurality of static permission records; and
a scheduler to trigger the processor to execute and compare the outcome of execution of at least one policy with the at least one appropriate static permission records in response to at least one of an occasional event, a schedule, or an action by administrator.

2. The system of claim 1, wherein each of the plurality of policies is a collection of one or more rules and each rule including at least one of user properties, resource properties, and environment properties as well as including an access decision which determines whether a corresponding user satisfying the user properties can or cannot have access to the at least one resource satisfying the resource properties, in an environment satisfying the environment properties.

3. The system of claim 2, wherein each of the plurality of policies includes a conflict resolution strategy to determine a rule priority for rules within a policy.

4. The system of claim 1, further comprising a violation database containing a plurality of static permission records which violate one or more of policies as computed by the processor.

5. The system of claim 1, further comprising an exception database containing a plurality of exception static permission records exempt from the plurality of policies.

6. The system of claim 1, wherein the processor is configured to add a new static permission record or remove one of the plurality of static permission records.

7. A method of auditing physical access to at least one resource, comprising:
providing a plurality of static permission records in a static resource database identifying access permissions for at least one credential holder to the at least one resource;
providing a plurality of policies in a policy database;
executing at least one policy of the plurality of policies via a processor to generate an outcome of execution of at least one policy;
comparing the outcome of execution of at least one policy with at least one appropriate static permission records of the plurality of static permission records via the processor; and
triggering the processor to execute and compare the outcome of execution of at least one policy with at least one appropriate static permission records in response to at least one of an occasional event, a schedule via a scheduler, or an action taken by administrator.

8. The method of claim 7, wherein each of the plurality of policies is a collection of one or more rules and each rule including at least one of a group consisting of user properties, resource properties, and environment properties as well as including an access decision which determines whether a corresponding user satisfying the user properties can or cannot have access to the at least one resource satisfying the resource properties, in an environment the satisfying environment properties.

9. The method of claim 8, further comprising determining a rule priority for rules within a policy of each of the plurality of policies via at least one conflict resolution strategy.

10. The method of claim 7, further comprising recording a plurality of violations in a violation database.

11. The method of claim 7, further comprising providing a plurality of exception static permission records exempt from the plurality of policies in an exception database.

12. The method of claim 7, further comprising adding a new static permission record or removing one of the plurality of static permission records via the processor.

13. The method of claim 7, further comprising specifying at least one of the plurality of policies via a graphical user interface.

14. A computer program product embodied on a tangible computer readable storage medium, the computer program product including instructions for causing a processor to execute operations comprising:
providing a plurality of static permission records in a static resource database identifying access permissions for at least one credential holder to at least one resource;
providing a plurality of policies in a policy database;
executing at least one policy of the plurality of policies via a processor to generate an outcome of execution of at least one policy;
comparing the outcomes of execution of at least one policy with at least one appropriate static permission records of the plurality of static permission records via the processor; and
triggering the processor to execute and compare the outcome of execution for at least one policy with appropriate static permission records in response to at least one of an occasional event or a schedule or an action by administrator.
